(19) United States
(12) Patent Application Publication
(10) Pub. No.: US 2019/0300354 A1
(43) Pub. Date: Oct. 3, 2019

(54) DISPENSING DEVICE HAVING A NOZZLE INSERT WITH A BAFFLE WALL

(71) Applicant: Grohe AG, Hemer (DE)

(72) Inventors: Felix HAMER, Iserlohn (DE); Guenter FAUST, Froendenberg (DE)

(73) Assignee: Grohe AG, Hemer (DE)

(21) Appl. No.: 16/370,055

(22) Filed: Mar. 29, 2019

(30) Foreign Application Priority Data
Mar. 29, 2018 (DE) 10 2018 107 603.7

(51) Int. Cl. B67D 1/00; B05B 1/02; B05B 1/34

(52) U.S. Cl. CPC B67D 1/0057; B05B 1/3402; B05B 1/02

(57) ABSTRACT

A dispensing device having a fitting housing with at least one first conduit for a carbonated liquid, a nozzle insert disposed in the at least one first conduit, wherein the nozzle insert has a guide channel with a first diameter, with which the carbonated liquid can be guided to a baffle wall of the nozzle insert so that the carbonated liquid can be vortexed by the baffle wall, an expansion space located downstream of the nozzle insert, wherein the expansion space has a second diameter which is greater than the first diameter of the guide channel, and an outlet opening disposed downstream of the expansion space and through which the vortexed carbonated liquid can exit the dispensing device.

This nonprovisional application claims priority under 35 U.S.C. § 119(a) to German Patent Application No. 10 2018 107 603.7, which was filed in Germany on Mar. 29, 2018, and which is herein incorporated by reference.

### BACKGROUND OF THE INVENTION

### Field of the Invention

The present invention relates to a dispensing device with which a carbonated liquid can be dispensed into a container.

### Description of the Background Art

Dispensing devices, for example, in the manner of sanitary fittings are known that regularly serve the need-based provision of water at a tap, a sink, utility sink, bathtub, and/or showers. For this purpose, the dispensing devices are supplied in particular with cold water with a cold water temperature and hot water with a hot water temperature. The cold water and hot water are mixed in particular with a mixing device of the dispensing devices, for example, in the manner of a mixing valve or a thermostatic mixing cartridge, to form mixed water having a desired mixed water temperature. The cold water temperature is in particular at most 25° C. (Celsius), preferably 1° C. to 25° C., particularly preferably 5° C. to 20° C., and/or the hot water temperature is in particular at most 90° C., preferably 25° C. to 90° C., particularly preferably 55° C. to 65° C. Furthermore, dispensing devices are known by means of which carbon dioxide (CO2) can be added to the cold water, hot water, and/or mixed water. Carbonated table water is thus produced from tap water by the addition of CO2. Furthermore, flavorings can be added to the cold water, hot water, and/or mixed water, so that different carbonated liquids can be provided by the dispensing devices. A disadvantage of the known dispensing devices, however, is that a CO2 concentration in the carbonated liquids after dispensing is not high enough and/or a flow pattern of the carbonated liquid after emerging from an outlet opening of the dispensing devices does not correspond to a desired quality.

### SUMMARY OF THE INVENTION

It is therefore an object of the present invention to solve at least partially the problems described with regard to the prior art, and in particular to provide a dispensing device with which a carbonated liquid with a high CO2 concentration and with an appealing flow pattern can be dispensed.

In an exemplary embodiment a dispensing device can include at least the following components: a fitting housing with at least one first conduit for a carbonated liquid; a nozzle insert disposed in the at least one first conduit, wherein the nozzle insert has a guide channel with a first diameter, with which the carbonated liquid can be guided to a baffle wall of the nozzle insert, so that the carbonated liquid can be vortexed by the baffle wall; an expansion space located downstream of the nozzle insert, wherein the expansion space has a second diameter which is greater than the first diameter of the guide channel; and an outlet opening disposed downstream of the expansion space and through which the vortexed carbonated liquid can exit the dispensing device.

The dispensing devices can be designed, for example, in the manner of a sanitary fitting and/or be used in particular for the needs-based provision of mixed water at a tap, a utility sink, a sink, a shower, and/or bathtub. Furthermore, a carbonated liquid can be dispensed by the dispensing device. The carbonated liquid is a carbon dioxide-containing liquid. For this purpose, the dispensing device can be connected to a source of the carbonated liquid and/or carbon dioxide (CO2) can be added by means of the dispensing device to a liquid, in particular tap water, for example, in the form of cold water, hot water, and/or mixed water. The dispensing device has a fitting housing that can be formed at least partially of plastic and/or metal, such as, for example, brass. The dispensing device can be attached by means of the fitting housing in particular to a support, for example, in the manner of a countertop, table top, or wall. The fitting housing has at least one first conduit for a carbonated liquid, by means of which the carbonated liquid can be conducted through the fitting housing and/or by means of which the carbonated liquid can be guided in the direction of an outlet opening of the dispensing device. Furthermore, the fitting housing can have at least one second conduit for a further liquid, such as, for example, cold water, hot water, and/or mixed water, by means of which the liquid can be conducted through the fitting housing and/or by means of which the liquid can be guided in the direction of the outlet opening of the dispensing device.

A nozzle insert can be disposed in the at least one first conduit. The nozzle insert is in particular a separate component that can be made at least partially tubular and/or out of plastic. The nozzle insert has a guide channel with a first diameter, with which the carbonated liquid can be guided to a baffle wall of the nozzle insert. If a first cross-sectional area (orthogonal to a longitudinal axis of the guide channel and/or to a flow direction of the carbonated liquid in the guide channel) of the guide channel is not circular, the first diameter is in particular an average diameter of the cross-sectional area of the guide channel. The carbonated liquid can be particularly compressed and/or accelerated by the guide channel. The guide channel can be formed, for example, in the manner of a guide bore. Furthermore, the guide channel can have a straight course and/or be formed without flow obstacles for the carbonated liquid. The carbonated liquid can preferably flow through the guide channel with a laminar flow. In addition, a longitudinal axis of the guide channel can extend parallel and/or coaxially to a longitudinal axis of the nozzle insert. The guide channel preferably extends from a first longitudinal end of the nozzle insert to the baffle wall, wherein the baffle wall is formed in particular at a second longitudinal end of the nozzle insert. The baffle wall can also have an area that is larger than a cross-sectional area of the guide channel. The area of the baffle wall can thus completely cover the cross-sectional area of the guide channel (in particular in the direction of the longitudinal axis of the guide channel). The carbonated liquid hits the baffle wall (in the flow direction of the carbonized liquid) at the end of the guide channel, so that it is vortexed by the baffle wall. Due to the impact of the carbonated liquid on the baffle wall, a flow direction of the carbonated liquid is deflected in particular by at least 45°, preferably (substantially) by 90°, and/or in particular in different directions. After impacting the baffle wall, the carbonated liquid preferably flows out of the nozzle insert through at least one radial outlet opening.

An expansion space for the carbonated liquid is formed downstream of the nozzle insert. The expansion space has in particular a second diameter that is greater than the first diameter of the guide channel and/or greater than the third diameter of the at least one first conduit. If a second cross-sectional area (orthogonal to a longitudinal axis of the expansion space and/or to a flow direction of the carbonated liquid in the expansion space) of the expansion space is not circular, the second diameter is in particular an average diameter of the cross-sectional area of the expansion space. If a third cross-sectional area (orthogonal to a longitudinal axis of the at least one first conduit and/or to a flow direction of the carbonated liquid in the at least one first conduit) of the at least one first conduit is not circular, the third diameter is in particular an average diameter of the cross-sectional area of the at least one first conduit. In particular, the second diameter of the expansion space can be at least 50% larger, preferably at least 100% larger, particularly preferably at least 200% larger than the first diameter of the guide channel and/or than the third diameter of the at least one first conduit. In particular, the carbonated liquid can expand in the expansion space, so that the flow pattern of the carbonated liquid emerging from the dispensing device is further improved. Furthermore, the baffle wall (with respect to a cross-sectional area of the expansion space) is preferably positioned (substantially) centrally in the expansion space. In addition, the at least one outlet opening of the nozzle insert (in particular in a radial direction of the nozzle insert) can preferably be arranged spaced from a boundary wall of the expansion space.

Downstream of the expansion space, the carbonated liquid flows to an outlet opening of the dispensing device, through which the carbonated liquid can flow out of the dispensing device. The impact of the carbonated liquid on the baffle wall creates a bubble effect, so that an attractive flow pattern is created when the carbonated liquid flows out of the outlet opening.

The baffle wall can be oriented at least partially orthogonal to a longitudinal axis of the guide channel. Preferably, the baffle wall is made (substantially) planar and/or runs completely orthogonal to the longitudinal axis of the guide channel.

In addition, the baffle wall can be connected via at least one web to the nozzle insert. The at least one web extends at the second longitudinal end of the nozzle insert, preferably in the direction of the longitudinal axis of the nozzle insert. The nozzle insert preferably has two webs, which are arranged offset by 180° to one another about the longitudinal axis of the nozzle insert. In a circumferential direction of the nozzle insert, the two webs preferably delimit two (radial) outlet openings of the nozzle insert.

The nozzle insert can have at least one outlet opening for the carbonated liquid between the guide channel and the baffle wall. Due to the at least one outlet opening, the carbonated liquid can preferably emerge from the nozzle insert in a radial direction of the nozzle insert.

The first diameter of the guide channel can be smaller than a third diameter of the at least one first conduit. In particular, the first diameter of the guide channel is smaller than the third diameter of the at least one first conduit immediately upstream of the nozzle insert. In this way, an acceleration of the carbonated liquid in the guide channel can be generated, so that it hits the baffle wall with a particularly high flow velocity.

The nozzle insert can have an inlet cone through which the carbonated liquid enters the guide channel. The inlet cone is, in particular, a rotational surface which is formed by a (preferably convex) curve rotating about the longitudinal axis of the nozzle insert. The inlet cone is located in particular at an opening of the guide channel opposite the baffle wall.

The nozzle insert can have a groove for a seal on a circumferential surface. The groove is in particular made annular, so that a seal in the manner of an O-ring can be placed in it.

The nozzle insert can be inserted through the outlet opening into a receiving space in the fitting housing. This means in particular that during assembly of the dispensing device, the nozzle insert can be inserted through the outlet opening into the receiving space, without further openings having to be provided in the fitting housing for the nozzle insert.

The receiving space can be formed in an adapter. The adapter is in particular a separate component that is formed preferably at least partially sleeve-shaped. In particular, the adapter has an inner diameter that substantially corresponds to an outer diameter of the nozzle insert. In addition, a hose for supplying the carbonated liquid can in particular be connectable to the adapter. Furthermore, the adapter can be attached to and/or in the fitting housing.

The guide channel, the baffle wall, and at least one outlet opening can be integrally formed by the nozzle insert.

According to a further aspect of the invention, a use of a nozzle insert having a guide channel, a baffle wall, and at least one outlet opening for guiding a carbonated liquid in a dispensing device is also proposed. For further details of the nozzle insert, reference is made to the description of the dispensing device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a partial view of an embodiment variant of a dispensing device in a sectional representation;

FIG. 2 is a nozzle insert in a perspective representation;

FIG. 3 is the nozzle insert in a sectional representation;

FIG. 4 is a partial view of an embodiment variant of a dispensing device;

FIG. 5 is an embodiment variant of the dispensing device in a sectional representation; and

FIG. 6 is an enlarged partial view of the embodiment variant of the dispensing device in the sectional representation.

### DETAILED DESCRIPTION

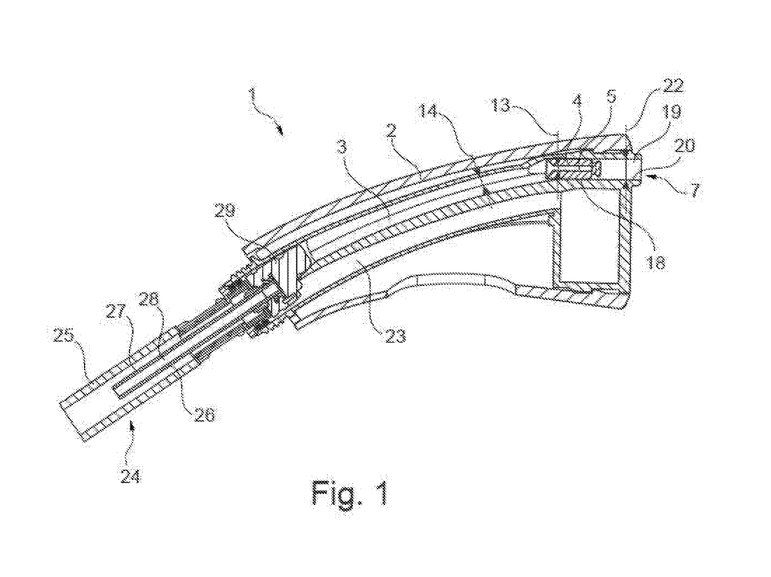

FIG. 1 shows a partial view of a first embodiment variant of a dispensing device 1 in a sectional representation. Only a spray fitting of dispensing device 1, by means of which a carbonated liquid and mixed water can be filled into a container (not shown here), such as, for example, a glass or a bottle, is shown in FIG. 1. A fitting housing 2 of dispensing device 1 is connected to a hose 24 which comprises a first tube line 25 and a second tube line 26 extending through first tube line 25. A first channel 27 with an annular cross-sectional area for the mixed water and a second channel 28 for the carbonated liquid are thus formed in hose 24. First channel 27 connects a mixed water source (not shown here), for example, a mixed water outlet of a mixing valve or thermostatic mixing valve, of dispensing device 1 to a connection adapter 29. Second channel 28 connects a carbonated liquid source (not shown here), such as, for example, a carbonator vessel, of dispensing device 1 to connection adapter 29. Connection adapter 29 connects first channel 27 to a first conduit 3 in fitting housing 2 and second channel 28 to a second conduit 23 in fitting housing 2. The carbonated liquid can be guided from connection adapter 29 to an outlet opening 7 via first conduit 3. In addition, the mixed water can be guided through second conduit 23 from connection adapter 29 to a further outlet opening (not shown here) for the mixed water. In first conduit 3, a nozzle insert 4 is disposed in a receiving space 20. Nozzle insert 4 has a guide channel 5 with a first diameter 13. First diameter 13 is greater than a third diameter 14 of first conduit 3. An expansion space 19 with a second diameter 22 is formed between nozzle insert 4 and outlet opening 7. Second diameter 22 of expansion space 19 is greater than first diameter 13 and second diameter 14.

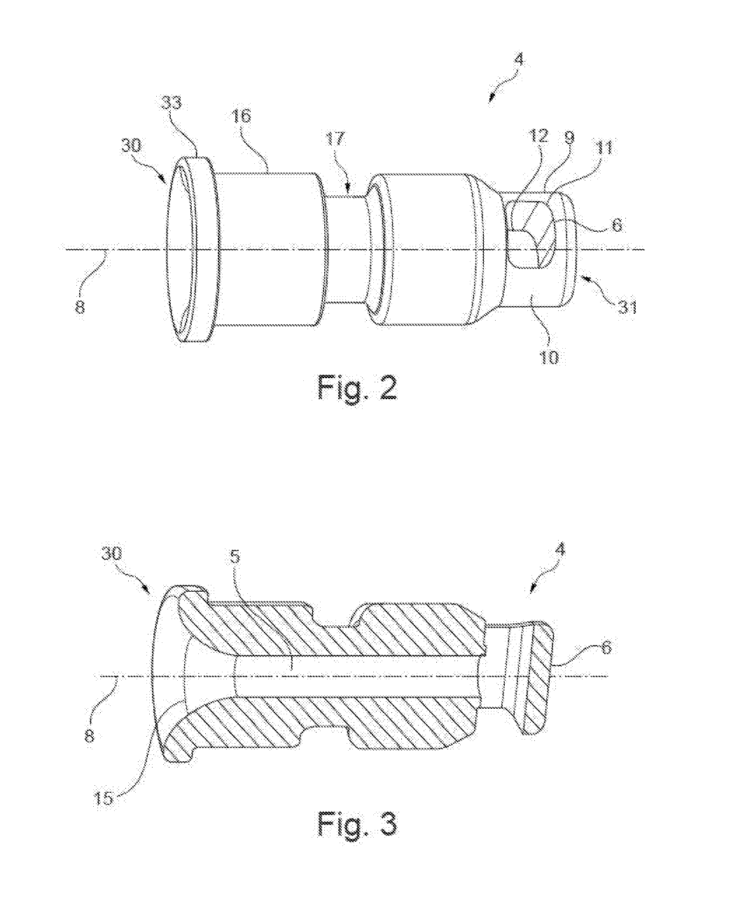

FIG. 2 shows nozzle insert 4 in a perspective representation. Nozzle insert 4 extends along a longitudinal axis 8 and has a circumferential collar 33 at a first longitudinal end 30 and a baffle wall 6 at a second longitudinal end 31. Baffle wall 6 runs orthogonal to longitudinal axis 8 of nozzle insert 4. Furthermore, baffle wall 6 is connected via a first web 9 and a second web 10 to nozzle insert 4, wherein first web 9 and second web 10 extend parallel to longitudinal axis 8. First web 9 and second web 10 are also arranged offset to another by 180° about longitudinal axis 8. A radial first outlet opening 11 and a radial second outlet opening 12 are formed between first web 9 and second web 10 in a circumferential direction of nozzle insert 4. In addition, nozzle insert 4 has a circumferential surface 16 with a circumferential groove 17 into which a seal 18, shown in FIG. 1, can be placed in the manner of an O-ring.

FIG. 3 shows the nozzle insert 4 in a sectional representation. Nozzle insert 4 has at first longitudinal end 30 an inlet cone, which opens into guide channel 5. Guide channel 5 extends from first longitudinal end 30 parallel and coaxially with longitudinal axis 8 in the direction of baffle wall 6.

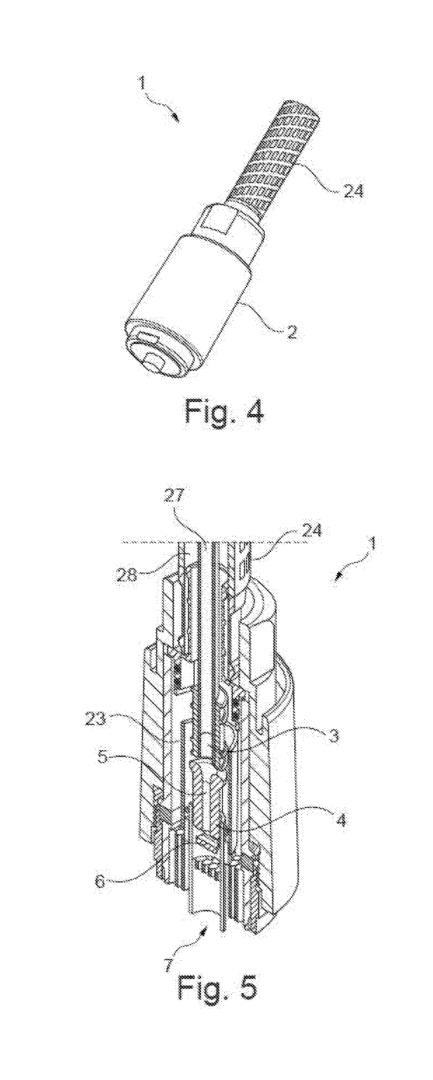

FIG. 4 shows a partial view of a second embodiment variant of a dispensing device 1 in which only a pull-out rinsing spray of dispensing device 1 is shown. The rinsing spray of dispensing device 1 has a fitting housing 2 to which a carbonated liquid and mixed water can be supplied by means of a hose 24. Hose 24 is formed identical to the hose 24 shown in FIG. 1.

It is evident from the sectional representation of dispensing device 1 in FIG. 5 that a first channel 27 for the carbonated water of hose 24 opens into a guide channel 5 of a nozzle insert 4. Nozzle insert 4 is formed identical to nozzle insert 4 shown in FIGS. 2 and 3. Furthermore, mixed water can be conducted by a second channel 28 of hose 24. The mixed water is passed through a second conduit 23 around nozzle insert 4 to an outlet opening 7.

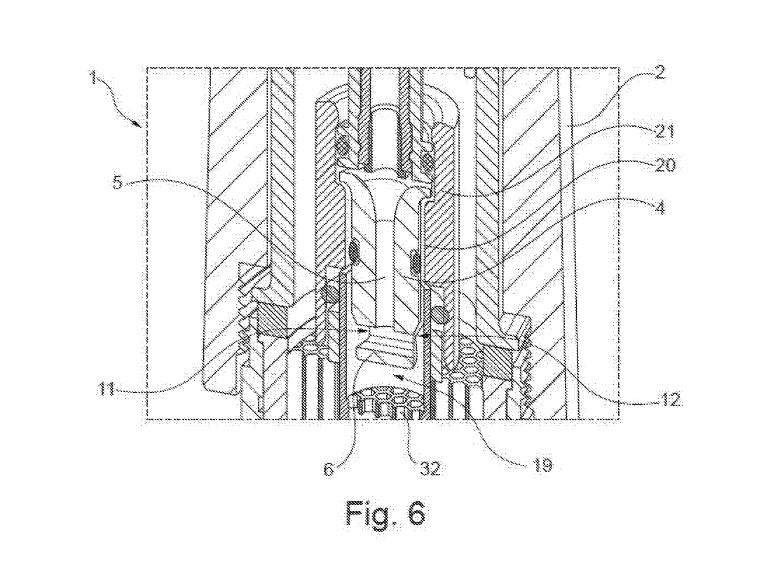

FIG. 6 shows an enlarged representation of the sectional representation of dispensing device 1 shown in FIG. 5. The carbonated water flows through guide channel 5 of nozzle insert 4 and hits baffle wall 6. As a result, the carbonated water is vortexed and exits via a first outlet opening 11 and a second outlet opening 12 out of nozzle insert 4 and enters into an expansion space 19. From there, the carbonated water flows through a mousseur 32 and exits out of outlet opening 7 shown in FIG. 5. In the embodiment variant shown here, nozzle insert 4 is held with an adapter 21 in fitting housing 2. For this purpose, a receiving space 20 for nozzle insert 4 is formed in adapter 21.

Carbonated water with a high CO2 concentration and with an attractive flow pattern can be dispensed by the present invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A dispensing device comprising:
a fitting housing with at least one first conduit for a carbonated liquid;
a nozzle insert disposed in the at least one first conduit, the nozzle insert having a guide channel with a first diameter, with which the carbonated liquid is adapted to be guided to a baffle wall of the nozzle insert so that the carbonated liquid is vortexed by the baffle wall;
an expansion space located downstream of the nozzle insert, the expansion space having a second diameter that is greater than the first diameter of the guide channel; and
an outlet opening disposed downstream of the expansion space and through which the vortexed carbonated liquid exits the dispensing device.

2. The dispensing device according to claim 1, wherein the baffle wall is oriented at least partially orthogonal to a longitudinal axis of the guide channel.

3. The dispensing device according to claim 1, wherein the baffle wall is connected via at least one web to the nozzle insert.

4. The dispensing device according to claim 1, wherein the nozzle insert has at least one outlet opening for the carbonated liquid between the guide channel and the baffle wall.

5. The dispensing device according to claim 1, wherein the first diameter of the guide channel is smaller than a third diameter of the at least one first conduit.

6. The dispensing device according to claim 1, wherein the nozzle insert is inserted through the outlet opening into a receiving space in the fitting housing.

7. The dispensing device according to claim 1, wherein the guide channel, the baffle wall, and at least one outlet opening are integrally formed by the nozzle insert.

8. The dispensing device according to claim 6, wherein the receiving space is formed in an adapter.

9. The dispensing device according to claim 1, wherein a nozzle insert, a guide channel, a baffle wall, and at least one outlet opening guides the carbonated liquid in the dispensing device.
